(19) United States
(12) Patent Application Publication
(10) Pub. No.: US 2016/0308916 A1
(43) Pub. Date: Oct. 20, 2016

(54) PROVIDING ACCESS NETWORK INFORMATION FOR IMS CALLS TERMINATING TO CIRCUIT-SWITCHED NETWORKS

(71) Applicant: TELEFONAKTIEBOLAGET L M ERICSSON (PUBL), Stockholm (SE)

(72) Inventors: David Brombal, Plano, TX (US); Motohiro Abe, McKinney, TX (US); Avery Kahawaii, Plano, TX (US)

(21) Appl. No.: 14/689,098

(22) Filed: Apr. 17, 2015

(51) Int. Cl. H04L 29/06; H04L 12/741

(52) U.S. Cl. CPC H04L 65/1069; H04L 65/1016; H04L 45/74

(57) ABSTRACT

A method in a network node is disclosed. The method comprises determining that a destination of a call is connected to a circuit-switched network, sending a request for routing information for the call to the circuit-switched network, and receiving a response to the request for routing information, the response to the request for routing information including access network information. The method further comprises storing the received access network information, receiving a response to a call setup message, the response to the call setup message associated with the call, and appending the stored access network information to the response to the call setup message. The method further comprises sending the response to the call setup message with the appended stored access network information to a second network node.

### TECHNICAL FIELD

The present disclosure relates, in general, to wireless communications and, more particularly, to methods and systems for providing access network information for IMS calls terminating to circuit-switched networks.

### BACKGROUND

In the IP Multimedia Sub-system (IMS), the P-Access-Network-Information (PANI) header is commonly included in Session Initiation Protocol (SIP) messages to provide information to the core network about specifics of the access network (e.g., LTE, Wi-Fi, UMTS, etc.) the user's device is connected to. This allows the network to make informed decisions about the types of services or the session handling that might be most appropriate (e.g., level of compression needed for video delivery).

The access network information is composed of multiple components, including access-class and access-information (which is dependent on the access-class). For example, for the class “3GPP-E-UTRAN” (LTE), the access information indicates the Country Code, Network Code, Tracking Area Code and the E-UTRAN Cell Identity (i.e., the specific cell site the user is connected to). As another example, for the access class 3GPP2-1X (CDMA), the access information provides the System ID, Network ID, Packet Zone ID and BASE_ID (again, the specific cell site).

The PANI header is usually added to SIP messages by the terminal itself, but can be provided by the network where appropriate (e.g., for hardwired terminals). The above process is generally followed by VoLTE terminals that use SIP natively. However, when Voice over LTE (VoLTE) users roam out of LTE coverage (which is an Internet Protocol (IP) or Packet-Switched (PS) network), and connect via traditional Circuit-Switched (CS) networks (e.g., CDMA or GSM), inclusion of a PANI header becomes problematic.

For example, after handling by IMS core nodes, a call being delivered (i.e, terminated) to a circuit-switched attached user is delivered to the circuit-switched network via a Media Gateway Control Function (MGCF). The MGCF interworks the IMS signaling (SIP) with the ISDN User Part (ISUP) signaling common in the circuit-switched network. While the user's terminal, or the handling switch, may possess all of the access network details required to build a PANI, the ISUP signaling protocol does not allow carrying this information back towards the MGCF for interworking into the SIP responses. This in turn prevents the user's access network details from being included in the charging or call detail records (CDR) for later storage and use or analysis. Thus, there is a need for a method of providing access network information for IMS calls terminating to circuit-switched networks.

### SUMMARY

To address the foregoing problems with existing solutions, disclosed is a method in a network node. The method comprises determining that a destination of a call is connected to a circuit-switched network, sending a request for routing information for the call to the circuit-switched network, and receiving a response to the request for routing information, the response to the request for routing information including access network information. The method further comprises storing the received access network information, receiving a response to a call setup message, the response to the call setup message associated with the call, and appending the stored access network information to the response to the call setup message. The method further comprises sending the response to the call setup message with the appended stored access network information to a second network node.

In certain embodiments, the network node includes a Terminating Access Domain Selection function. The destination of the call may be a roaming voice over LTE terminal connected to the circuit-switched network. The access network information may comprise one or more of an access class and access information. The access network information may comprise a switch number of a switch to which the destination of the call is attached. The response to the request for routing information may be received from a home location register. The response to the call setup message may comprise a session initiation protocol message.

In certain embodiments, the method further comprises accessing the stored access network information. The method may further comprise associating the stored access network information with the call. Sending the response to the call setup message with the appended access network information to a second network node may comprise sending the response to the call setup message with the appended access network information to a core IP Multimedia Subsystem network node. The method may further comprise generating a P-Access Network Information (PANI) header that includes the stored access network information, and appending the stored access network information to the response to the call setup message may comprise appending the generated PANI header to the response to the call setup message.

Also disclosed is a network node. The network node comprises one or more processors. The one or more processors are configured to determine that a destination of a call is connected to a circuit-switched network, send a request for routing information for the call to the circuit-switched network, and receive a response to the request for routing information, the response to the request for routing information including access network information. The one or more processors are configured to store the received access network information, receive a response to a call setup message, the response to the call setup message associated with the call, and append the stored access network information to the response to the call setup message. The one or more processors are configured to send the response to the call setup message with the appended stored access network information to a second network node.

Certain embodiments of the present disclosure may provide one or more technical advantages. For example, in certain embodiments access network information that is otherwise unavailable may be provided to the IMS subsystem, which may advantageously allow the information to be captured in charging records associated with the terminating party. This may provide enhanced network operation/performance metrics, or billing opportunities. As another example, certain embodiments do not require modifications to the MGCF, which is often a function based on existing switching equipment, which can make changes more difficult. As yet another example, certain embodiments may not require modifications to the ISUP signaling used to connect the MGCF to the CS domain entities. Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates multiple wireless communication networks, in accordance with certain embodiments;

FIG. 2 is a signal flow diagram, in accordance with an embodiment;

FIG. 3 is a flow chart of a method in a network node, in accordance with an embodiment;

FIG. 4 is a block schematic of an exemplary wireless device, in accordance with certain embodiments;

FIG. 5 is a block schematic of an exemplary radio network node, in accordance with certain embodiments; and

FIG. 6 is a block schematic of an exemplary radio network controller or core network node, in accordance with certain embodiments.

### DETAILED DESCRIPTION

As described above, there is a need to provide access network information for IMS calls terminating to circuit-switched networks. The present disclosure contemplates various embodiments that may provide access network information for a terminating user when in a circuit-switched-connected situation. For example, in certain embodiments, a network node may determine that a destination of a call is connected to a circuit-switched network. The network node may send a request for routing information for the call to the circuit-switched network, and receive a response to the request for routing information. The response to the request for routing information may include access network information. The network node may store the received access network information. The network node may receive a response to a call setup message associated with the call, append the stored access network information to the response to the call setup message, and send the response to the call setup message with the appended stored access network information to a second network node.

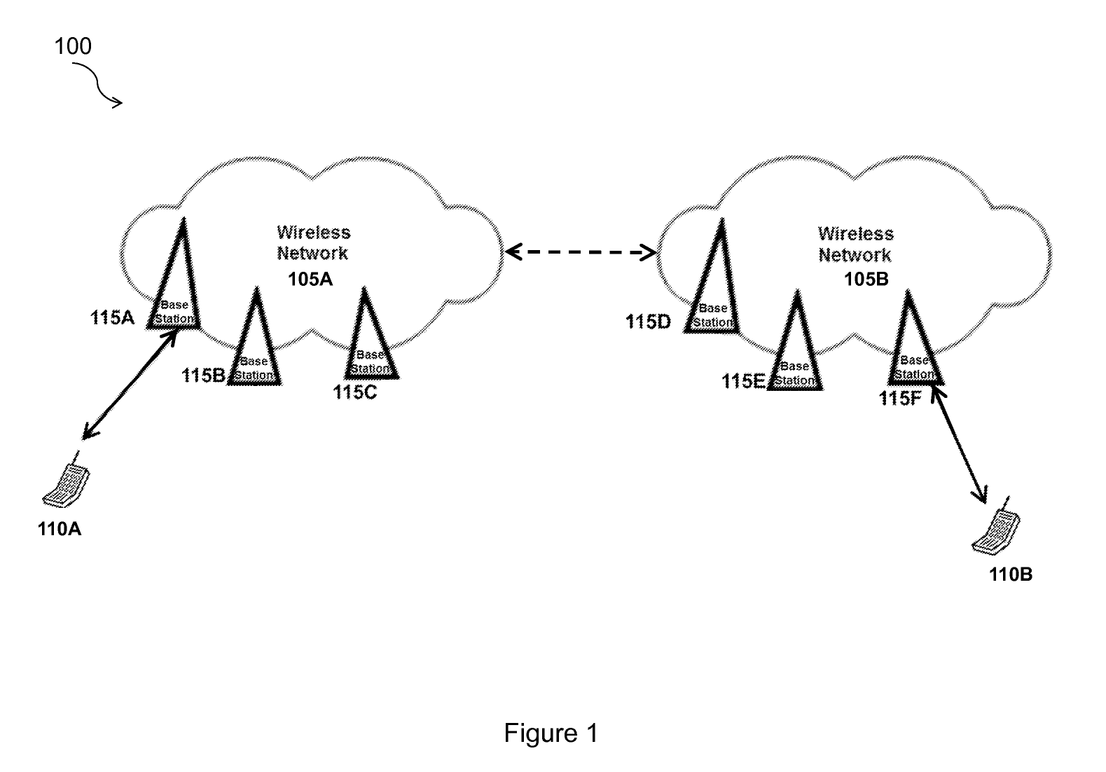

FIG. 1 illustrates multiple wireless networks, in accordance with certain embodiments. More particularly, FIG. 1 illustrates two networks 105A and 105B. Wireless networks 105A and 105B include one or more wireless device(s) 110 (which may be interchangeably referred to as user equipments (UEs) or terminals 110) and network node(s) 115 (which may be interchangeably referred to as eNBs 115). In certain embodiments, one or more of wireless networks 105A and 105B may include other elements, such as one or more radio network controller(s) and/or core network node(s). Wireless networks 105A and 105B may be any suitable type of networks. For example, in certain embodiments wireless network 105A may be a packet-switched or IP based network, such as an IMS network, and wireless network 105B may be a circuit-switched network, such as a CDMA or GSM network.

A wireless device 110 may communicate with a network node 115 over a wireless interface. For example, wireless device 110A may transmit wireless signals to network node 115A and/or receive wireless signals from network node 115A. As another example, wireless device 110B may transmit wireless signals to network node 115F and/or receive wireless signals from network node 115F. The wireless signals may contain voice traffic, data traffic, control signals, and/or any other suitable information. In some embodiments, an area of wireless signal coverage associated with a network node 115 may be referred to as a cell.

In certain embodiments, network node 115 may interface with a radio network controller. The radio network controller may control network node 115 and may provide certain radio resource management functions, mobility management functions, and/or other suitable functions. The radio network controller may interface with a core network node. For example, in certain embodiments, a radio network controller may interface with a core network node via an interconnecting network. The interconnecting network may refer to any interconnecting system capable of transmitting audio, video, signals, data, messages, or any combination of the preceding.

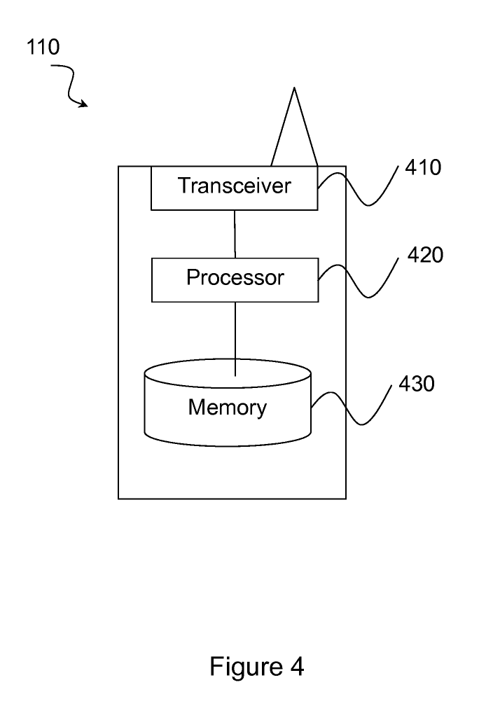

In some embodiments, the core network node may manage the establishment of communication sessions and various other functionality for wireless device 110. Wireless device 110 may exchange certain signals with the core network node using the non-access stratum layer. In non-access stratum signaling, signals between wireless device 110 and the core network node may be transparently passed through the radio access network. Example embodiments of wireless device 110, network node 115, and other network nodes (such as a radio network controller or core network node) are described with respect to FIGS. 4, 5, and 6, respectively.

As described above, in certain embodiments wireless network 105A may be an LTE network, and wireless network 105B may be a circuit-switched network. In certain embodiments, a user of wireless device 110A connected to wireless network 105A may call another user's wireless device, such as wireless device 110B. Wireless device 110B may be connected to circuit-switched network 105B. For example, wireless device 110B may be a roaming VoLTE terminal connected to the circuit-switched network. To deliver a terminating call to an IMS user that may be attached via either an LTE (i.e., IP) network or a CDMA/GSM (i.e., circuit-switched) network, IMS defines a Terminating-Access Domain Selection (T-ADS) function. The role of the T-ADS function is to keep track of the current attachment (access) technology of the user (i.e., packet-switched or circuit-switched). The T-ADS function may be included at any suitable point in the network. For example, in certain embodiments, the T-ADS function may be included in network node 115, or in a core network node. Terminating calls are routed via the T-ADS function, which then routes the messages towards either the packet-switched network 105A or circuit-switched network 105B as one of the last steps in delivery of the call.

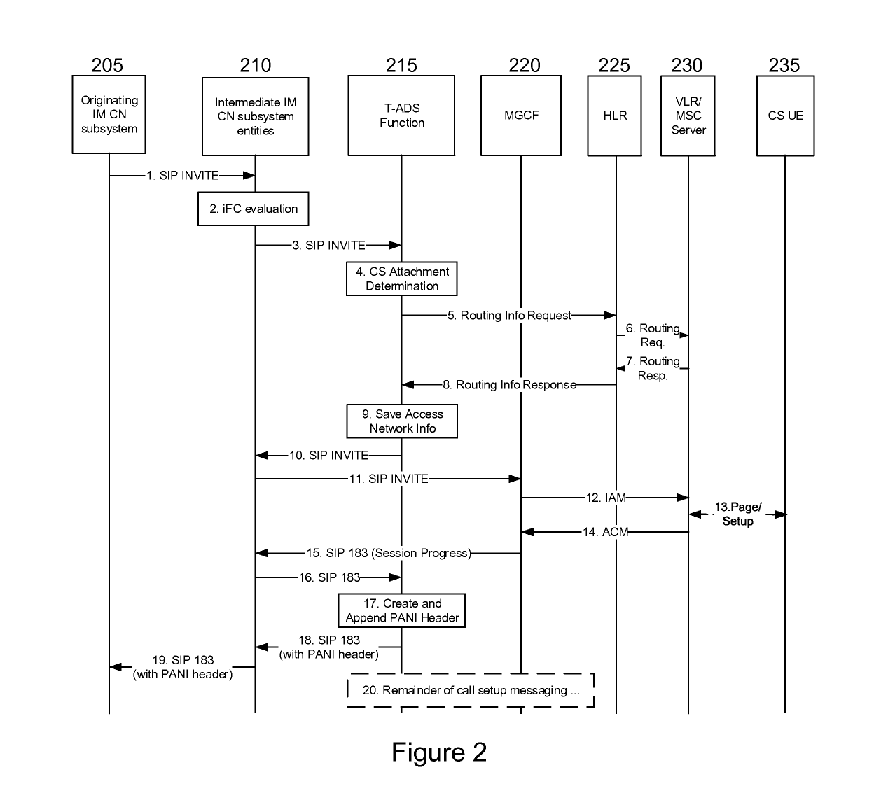

When the T-ADS function determines that the user is attached to circuit-switched network 105B, it will query the circuit-switched network for routing instructions. The response to this query can be configured to include relevant access network information. In certain embodiments, the T-ADS function may save this information, and may subsequently append the stored access network information to a response to a call setup message associated with the call. The response to the call setup message may be returned from an MGCF during call set up. Network node 115 may send the response to the call setup message with the appended stored access network information to a second network node. The second network node may be any suitable network node. For example, in certain embodiments, the second network node may be a core IMS network node. In certain embodiments, the network node including the T-ADS function may generate a PANI header that includes the stored access network information, and append the generated PANI header to the response to the call setup message. This process is described in more detail below in relation to the signal flow diagram illustrated in FIG. 2.

FIG. 2 is a signal flow diagram, in accordance with an embodiment. At step 1, originating IM CN subsystem 205 sends a SIP INVITE message to one or more intermediate IM CN subsystem entities 210. At step 2, intermediate IM CN subsystem entities 210 perform iFC evaluation. At step 3, intermediate IM CN subsystem entities 210 send a SIP INVITE message to T-ADS function 215. T-ADS function 215 is the entity that determines the correct network (i.e., packet-switched or circuit-switched) for delivery of the call. At step 4, T-ADS function 215 determines whether the call is to be delivered to the circuit-switched network. In other words, T-ADS function 215 determines whether the destination of the call is connected to the packet-switched or circuit-switched network. At step 5, if the user that is the destination of the call is found to be attached to the circuit-switched network, T-ADS function 215 queries that circuit-switched network for up-to-date location and routing information. In certain embodiments, this may involve querying Home Location Register (HLR) 225, which in turn may query Visiting Location Register (VLR) or serving mobile switch (MSC) 230 for a temporary routing number that can be used to route the call to the switch that is currently serving the roamer. At step 5, T-ADS function 215 sends a request for routing information to HLR 225. At step 6, HLR 225 routes the request for routing information to VLR/MSC 230. At step 7, VLR/MSC 230 sends a response to the request for routing information to HLR 225. At step 8, HLR 225 sends the response to the request for routing information to T-ADS Function 215.

The routing queries may be made using any suitable types of messages. For example, in CDMA (ANSI) networks, the routing queries may be done with Location Request/Response and Routing Request/Response messages. As another example, in GSM (MAP) based networks, this can be done using MAP_Send_Routing_Info Request/Response and MAP_Provide_Roaming_Number Request/Response messages (see steps 5 through 8 described above). In addition to returning the necessary routing information, these messages can carry back specific access network information to the T-ADS function 215. At step 9, T-ADS function 215 saves the received access network information against the particular call/session being established.

At this point, T-ADS function 215 forwards the call setup messaging towards the correct domain. At step 10, T-ADS function 215 forwards the SIP INVITE to intermediate IM CN subsystem entities 210. At step 11, intermediate IM CN subsystem entities 210 sends the SIP INVITE message to MGCF 220. At step 12, MGCF 220 sends an IAM message to VLR/MSC 230. At step 13, VLR/MSC 230 and the destination circuit-switched UE 235 exchange Page/Setup messages. At step 14, VLR/MSC 230 sends an ACM message to MGCF 220. At step 15, MGCF 220 sends a SIP 183 (Session Progress) message to intermediate IM CN subsystem entities 210.

At step 16, intermediate IM CN subsystem entities 210 send a SIP 183 message to T-ADS function 215. As described above, when responses arrive from the destination (e.g., the SIP 183 message sent at step 16), there may not be a PANI header present. In certain embodiments, T-ADS function 215 has access network information saved against this session from an earlier request to the circuit-switched network. At step 17, T-ADS function 215 may use this information to build a PANI header, and insert it into the response before passing it along.

In steps 18-20 and beyond, the added PANI header can be used as needed by any node in the IM Subsystem, and used to augment CDR records. In cases where the called party was determined to be packet-switched (e.g. LTE) attached, no routing queries (such as the ANSI or MAP queries described above) would be needed. The call would be delivered to the packet-switched-attached device and the device itself would be expected to include a PANI header in its response messages. T-ADS function 215 would simply pass this header along unaltered.

The various embodiments described herein may have certain advantages. Recall that in existing networks, a user's terminal, or the handling switch, may possess all of the access network details, but the ISUP signaling protocol does not allow this information to be carried back towards the MGCF for interworking into the SIP responses. This prevents the user's access network details from being included in the charging or call detail records (CDR) for later storage and use or analysis. By appending the access network information to responses to call setup messages (such as, for example, appending a generated PANI header to a call setup message as described above in relation to step 17), the access network information that would otherwise be unavailable to the IMS subsystem is provided. The access network information may be used in any suitable manner. For example, this information can be captured in charging records associated with the terminating party. This may advantageously provide enhanced network operation/performance metrics or billing opportunities. As another example, certain embodiments do not require modifications to MGCF 220, which is often a function based on existing switching equipment, making changes more difficult. In addition, there are often a large number of these nodes in a network which would all require updates if this was to be retrofitted. In certain embodiments, T-ADS function 215 may be provided by a centralized node (though typically duplicated for redundancy). As another example, certain embodiments may use Information Elements (IEs) that are already defined for the messages used to locate and route to the circuit-switched network, and advantageously do not require modifications to the ISUP signaling used to connect MGCF 220 to the circuit-switched domain entities.

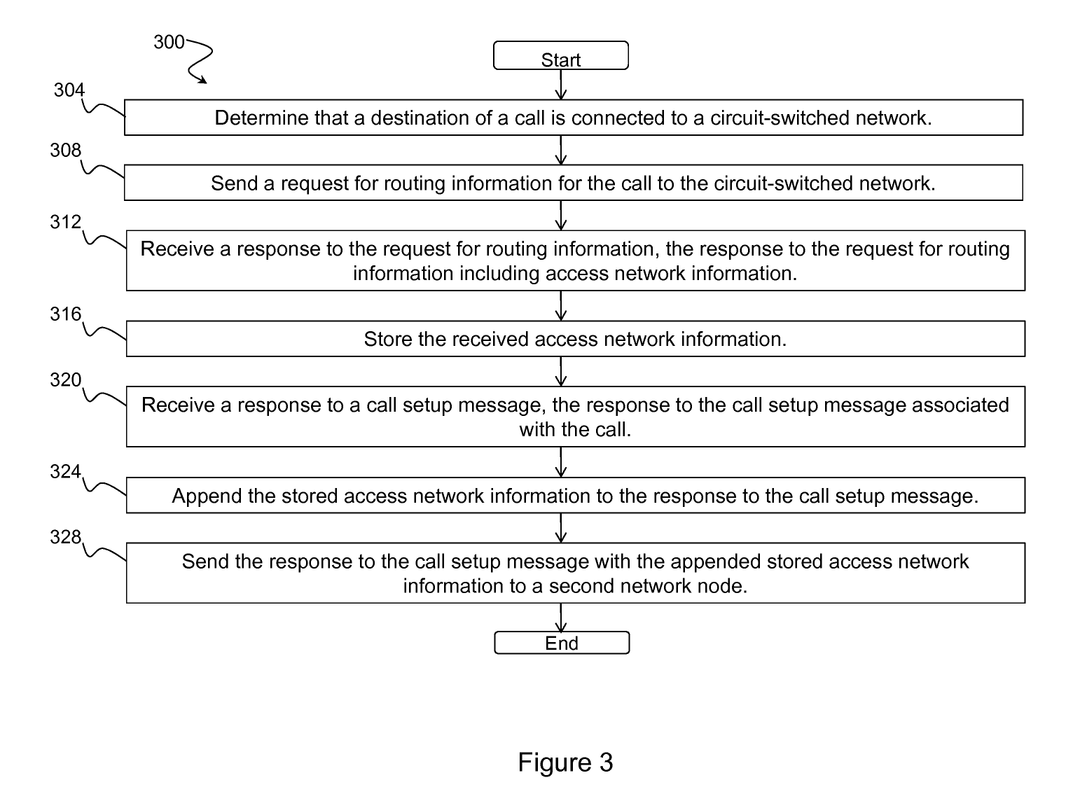

FIG. 3 is a flow chart of a method in a network node, in accordance with an embodiment. The method begins at step 304, where the network node determines that a destination of a call is connected to a circuit-switched network. In certain embodiments, the network node may include a Terminating Access Domain Selection function. The destination of the call may be a roaming voice over LTE terminal connected to the circuit-switched network.

At step 308, the network node sends a request for routing information for the call to the circuit-switched network. At step 312, the network node receives a response to the request for routing information, the response to the request for routing information including access network information. The response to the request for routing information may be received from a home location register. The access network information may include any suitable information. For example, the access network information may include one or more of an access class and access information. As another example, the access network information may include a switch number of a switch to which the destination of the call is attached.

At step 316, the network node stores the received access network information. In certain embodiments, the network node may associate the stored access network information with the call. At step 320, the network node receives a response to a call setup message, the response to the call setup message associated with the call. The response to the call setup message may be a session initiation protocol message. In certain embodiments, the network node may access the stored access network information.

At step 324, the network node appends the stored access network information to the response to the call setup message. In certain embodiments, the network node may generate a P-Access Network Information (PANI) header that includes the stored access network information, and append the generated PANI header to the response to the call setup message.

At step 328, the network node sends the response to the call setup message with the appended stored access network information to a second network node. In certain embodiments, the network node may send the response to the call setup message with the appended access network information to a core IP Multimedia Subsystem network node.

FIG. 4 is a block schematic of an exemplary wireless device 110, in accordance with certain embodiments. Wireless device 110 may refer to any type of wireless device communicating with a node and/or with another wireless device in a cellular or mobile communication system. Examples of wireless device 110 include a mobile phone, a smart phone, a PDA (Personal Digital Assistant), a portable computer (e.g., laptop, tablet), a sensor, a modem, a machine-type-communication (MTC) device/machine to machine (M2M) device, laptop embedded equipment (LEE), laptop mounted equipment (LME), USB dongles, a device-to-device capable device, or another device that can provide wireless communication. A wireless device 110 may also be referred to as user equipment (UE), a station (STA), a device, or a terminal in some embodiments. Wireless device 110 includes transceiver 410, processor 420, and memory 430. In some embodiments, transceiver 410 facilitates transmitting wireless signals to and receiving wireless signals from network node 115 (e.g., via an antenna), processor 420 executes instructions to provide some or all of the functionality described above as being provided by wireless device 110, and memory 430 stores the instructions executed by processor 420.

Processor 420 may include any suitable combination of hardware and software implemented in one or more modules to execute instructions and manipulate data to perform some or all of the described functions of wireless device 110. In some embodiments, processor 420 may include, for example, one or more computers, one or more central processing units (CPUs), one or more microprocessors, one or more applications, and/or other logic.

Memory 430 is generally operable to store instructions, such as a computer program, software, an application including one or more of logic, rules, algorithms, code, tables, etc. and/or other instructions capable of being executed by a processor. Examples of memory 430 include computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information.

Other embodiments of wireless device 110 may include additional components beyond those shown in FIG. 4 that may be responsible for providing certain aspects of the wireless device's functionality, including any of the functionality described above and/or any additional functionality (including any functionality necessary to support the solution described above).

In certain embodiments, wireless device 110 may include one or more modules. For example, wireless device 110 may include a determining module, a communication module, a receiver module, an input module, a display module, and any other suitable modules. The determining module may perform the processing functions of wireless device 110. The determining module may include or be included in processor 420. The determining module may include analog and/or digital circuitry configured to perform any of the functions of the determining module and/or processor 420. The functions of the determining module described above may, in certain embodiments, be performed in one or more distinct modules.

The communication module may perform the transmission functions of wireless device 110. The communication module may transmit messages to one or more of network nodes 115 of network 100. The communication module may include a transmitter and/or a transceiver, such as transceiver 410. The communication module may include circuitry configured to wirelessly transmit messages and/or signals. In particular embodiments, the communication module may receive messages and/or signals for transmission from the determining module.

The receiving module may perform the receiving functions of wireless device 110. The receiving module may include a receiver and/or a transceiver. The receiving module may include circuitry configured to wirelessly receive messages and/or signals. In particular embodiments, the receiving module may communicate received messages and/or signals to the determining module.

The input module may receive user input intended for wireless device 110. For example, the input module may receive key presses, button presses, touches, swipes, audio signals, video signals, and/or any other appropriate signals. The input module may include one or more keys, buttons, levers, switches, touchscreens, microphones, and/or cameras. The input module may communicate received signals to the determining module.

The display module may present signals on a display of wireless device 110. The display module may include the display and/or any appropriate circuitry and hardware configured to present signals on the display. The display module may receive signals to present on the display from the determining module.

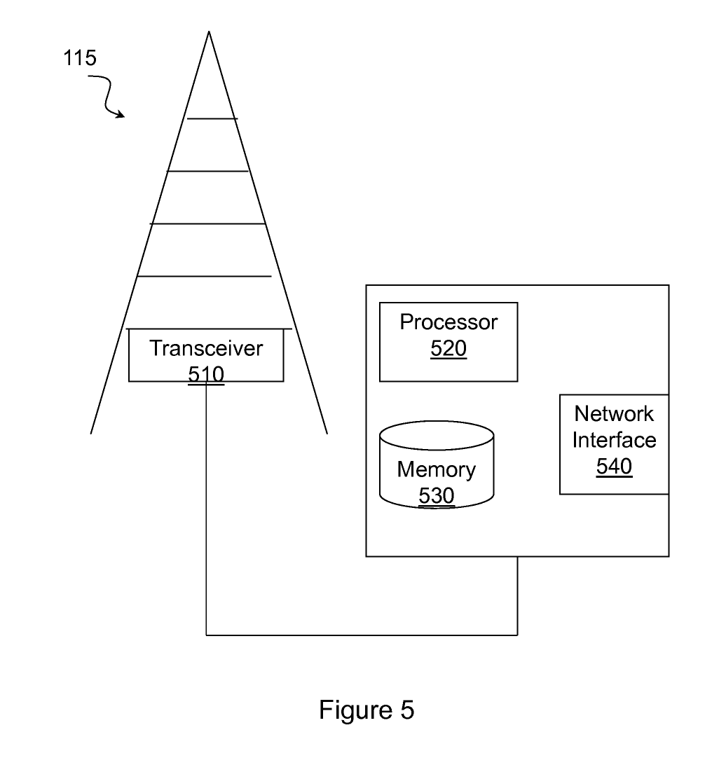

FIG. 5 is a block schematic of an exemplary network node 115, in accordance with certain embodiments. Network node 115 may be any type of radio network node or any network node that communicates with a UE and/or with another network node. Examples of network node 115 include an eNodeB, a node B, a base station, a wireless access point (e.g., a Wi-Fi access point), a low power node, a base transceiver station (BTS), relay, donor node controlling relay, transmission points, transmission nodes, remote RF unit (RRU), remote radio head (RRH), multi-standard radio (MSR) radio node such as MSR BS, nodes in distributed antenna system (DAS), O&M, OSS, SON, positioning node (e.g., E-SMLC), MDT, or any other suitable network node. Network nodes 115 may be deployed throughout network 100 as a homogenous deployment, heterogeneous deployment, or mixed deployment. A homogeneous deployment may generally describe a deployment made up of the same (or similar) type of network nodes 115 and/or similar coverage and cell sizes and inter-site distances. A heterogeneous deployment may generally describe deployments using a variety of types of network nodes 115 having different cell sizes, transmit powers, capacities, and inter-site distances. For example, a heterogeneous deployment may include a plurality of low-power nodes placed throughout a macro-cell layout. Mixed deployments may include a mix of homogenous portions and heterogeneous portions.

Network node 115 may include one or more of transceiver 510, processor 520, memory 530, and network interface 540. In some embodiments, transceiver 510 facilitates transmitting wireless signals to and receiving wireless signals from wireless device 110 (e.g., via an antenna), processor 520 executes instructions to provide some or all of the functionality described above as being provided by a network node 115, memory 530 stores the instructions executed by processor 520, and network interface 540 communicates signals to backend network components, such as a gateway, switch, router, Internet, Public Switched Telephone Network (PSTN), core network nodes or radio network controllers, etc.

Processor 520 may include any suitable combination of hardware and software implemented in one or more modules to execute instructions and manipulate data to perform some or all of the described functions of network node 115. In some embodiments, processor 520 may include, for example, one or more computers, one or more central processing units (CPUs), one or more microprocessors, one or more applications, and/or other logic.

Memory 530 is generally operable to store instructions, such as a computer program, software, an application including one or more of logic, rules, algorithms, code, tables, etc. and/or other instructions capable of being executed by a processor. Examples of memory 530 include computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information.

In some embodiments, network interface 540 is communicatively coupled to processor 520 and may refer to any suitable device operable to receive input for network node 115, send output from network node 115, perform suitable processing of the input or output or both, communicate to other devices, or any combination of the preceding. Network interface 540 may include appropriate hardware (e.g., port, modem, network interface card, etc.) and software, including protocol conversion and data processing capabilities, to communicate through a network.

In certain embodiments, network node 115 may include a determining module, a communication module, a receiving module, and any other suitable modules. In some embodiments, one or more of the determining module, communication module, receiving module, or any other suitable module may be implemented using one or more processors 520 of FIG. 5. In certain embodiments, the functions of two or more of the various modules may be combined into a single module.

The determining module may perform the processing functions of network node 115. For example, the determining module may determine that a destination of a call is connected to a circuit-switched network. As another example, the determining module may store received access network information (e.g., in memory 530). As yet another example, the determining module may append the stored access network information to a response to a call setup message.

The communication module may perform the transmission functions of network node 115. The communication module may transmit messages to one or more of wireless devices 110. For example, the communication module may send a request for routing information for a call to a circuit-switched network. As another example, the communication module may send the response to the call setup message with the appended stored access network information to a second network node. The communication module may include a transmitter and/or a transceiver, such as transceiver 510. The communication module may include circuitry configured to wirelessly transmit messages and/or signals. In particular embodiments, the communication module may receive messages and/or signals for transmission from the determining module or any other module.

The receiving module may perform the receiving functions of network node 115. The receiving module may receive any suitable information from a wireless device. For example, the receiving module may receive a response to a request for routing information. As another example, the receiving module may receive a response to a call setup message. The receiving module may include a receiver and/or a transceiver. The receiving module may include circuitry configured to wirelessly receive messages and/or signals. In particular embodiments, the receiving module may communicate received messages and/or signals to the determining module or any other suitable module.

Other embodiments of network node 115 may include additional components beyond those shown in FIG. 5 that may be responsible for providing certain aspects of the radio network node's functionality, including any of the functionality described above and/or any additional functionality (including any functionality necessary to support the solutions described above). The various different types of network nodes may include components having the same physical hardware but configured (e.g., via programming) to support different radio access technologies, or may represent partly or entirely different physical components.

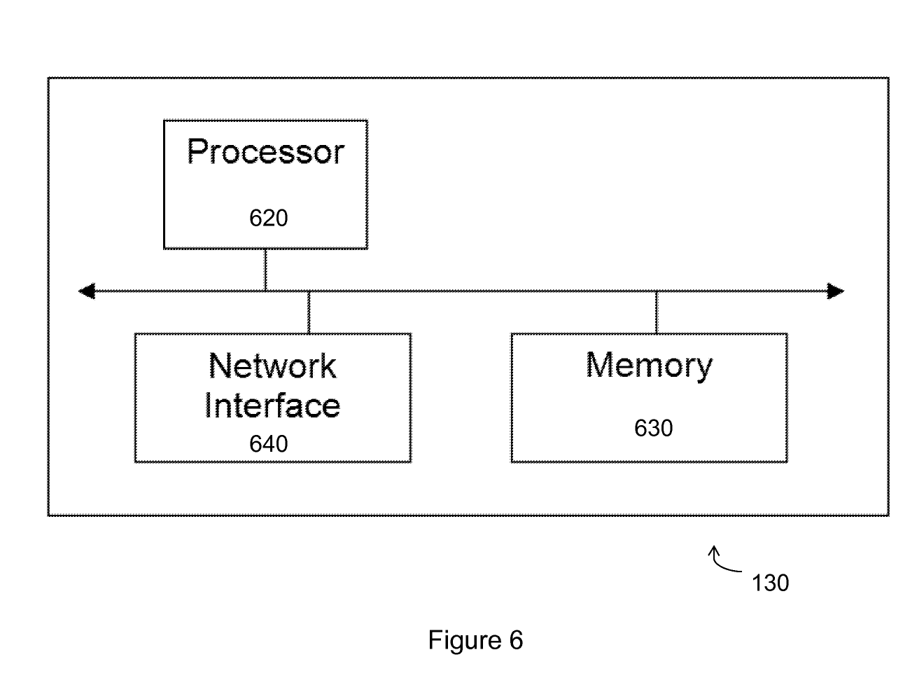

FIG. 6 is a block schematic of an exemplary radio network controller or core network node 130, in accordance with certain embodiments. Examples of network nodes can include a mobile switching center (MSC), a serving GPRS support node (SGSN), a mobility management entity (MME), a radio network controller (RNC), a base station controller (BSC), and so on. The radio network controller or core network node 130 include processor 620, memory 630, and network interface 640. In some embodiments, processor 620 executes instructions to provide some or all of the functionality described above as being provided by the network node, memory 630 stores the instructions executed by processor 620, and network interface 640 communicates signals to any suitable node, such as a gateway, switch, router, Internet, Public Switched Telephone Network (PSTN), network nodes 115, radio network controllers or core network nodes 130, etc.

Processor 620 may include any suitable combination of hardware and software implemented in one or more modules to execute instructions and manipulate data to perform some or all of the described functions of the radio network controller or core network node 130. In some embodiments, processor 920 may include, for example, one or more computers, one or more central processing units (CPUs), one or more microprocessors, one or more applications, and/or other logic.

Memory 630 is generally operable to store instructions, such as a computer program, software, an application including one or more of logic, rules, algorithms, code, tables, etc. and/or other instructions capable of being executed by a processor. Examples of memory 630 include computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information.

In some embodiments, network interface 640 is communicatively coupled to processor 620 and may refer to any suitable device operable to receive input for the network node, send output from the network node, perform suitable processing of the input or output or both, communicate to other devices, or any combination of the preceding. Network interface 640 may include appropriate hardware (e.g., port, modem, network interface card, etc.) and software, including protocol conversion and data processing capabilities, to communicate through a network.

Other embodiments of the network node may include additional components beyond those shown in FIG. 6 that may be responsible for providing certain aspects of the network node's functionality, including any of the functionality described above and/or any additional functionality (including any functionality necessary to support the solution described above).

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods described herein without departing from the scope of the disclosure. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

Abbreviations used in the preceding description include:
ANSI American National Standards Institute
CDMA Code Division Multiple Access (a radio access technology)
CS Circuit Switch
GSM Global System for Mobile communication (English version)
HLR Home Location Register
IMS IP Multimedia System (IMS)
IP Internet Protocol
ISDN Integrated Digital Subscriber Network
ISUP ISDN User Part
LTE Long Term Evolution (a radio access technology)
MAP Mobile Application Part
MGCF Media Gateway Control Function
PANI P-Access-Network-Information
PS Packet Switch
SIP Session Initiation Protocol
T-ADS Terminating Access Domain Selection
UMTS Universal Mobile Telecommunication System
VLR Visited/Visiting Location Register
VoLTE Voice over LTE

1. A method in a network node, comprising:
determining that a destination of a call is connected to a circuit-switched network;
sending a request for routing information for the call to the circuit-switched network;
receiving a response to the request for routing information, the response to the request for routing information including access network information;
storing the received access network information;
receiving a response to a call setup message, the response to the call setup message associated with the call;
appending the stored access network information to the response to the call setup message; and
sending the response to the call setup message with the appended stored access network information to a second network node.

2. The method of claim 1, further comprising accessing the stored access network information.

3. The method of claim 1, wherein the access network information comprises one or more of an access class and access information.

4. The method of claim 1, wherein the access network information comprises a switch number of a switch to which the destination of the call is attached.

5. The method of claim 1, wherein the network node includes a Terminating Access Domain Selection function.

6. The method of claim 1, further comprising associating the stored access network information with the call.

7. The method of claim 1, wherein the response to the request for routing information is received from a home location register.

8. The method of claim 1, wherein sending the response to the call setup message with the appended access network information to a second network node comprises sending the response to the call setup message with the appended access network information to a core IP Multimedia Subsystem network node.

9. The method of claim 1, wherein the response to the call setup message comprises a session initiation protocol message.

10. The method of claim 1, wherein the destination of the call is a roaming voice over LTE terminal connected to the circuit-switched network.

11. The method of claim 1, further comprising generating a P-Access Network Information (PANI) header that includes the stored access network information, wherein appending the stored access network information to the response to the call setup message comprises appending the generated PANI header to the response to the call setup message.

12. A network node, comprising:
one or more processors configured to:
determine that a destination of a call is connected to a circuit-switched network;
send a request for routing information for the call to the circuit-switched network;
receive a response to the request for routing information, the response to the request for routing information including access network information;
store the received access network information;
receive a response to a call setup message, the response to the call setup message associated with the call;
append the stored access network information to the response to the call setup message; and
send the response to the call setup message with the appended stored access network information to a second network node.

13. The network node of claim 12, wherein the one or more processors are further configured to access the stored access network information.

14. The network node of claim 12, wherein the access network information comprises one or more of an access class and access information.

15. The network node of claim 12, wherein the access network information comprises a switch number of a switch to which the destination of the call is attached.

16. The network node of claim 12, wherein the network node includes a Terminating Access Domain Selection function.

17. The network node of claim 12, wherein the one or more processors are further configured to associate the stored access network information with the call.

18. The network node of claim 12, wherein the response to the request for routing information is received from a home location register.

19. The network node of claim 12, wherein the one or more processors configured to send the response to the call setup message with the appended access network information to a second network node comprises one or more processors configured to send the response to the call setup message with the appended access network information to a core IP Multimedia Subsystem network node.

20. The network node of claim 12, wherein the response to the call setup message comprises a session initiation protocol message.

21. The network node of claim 12, wherein the destination of the call is a roaming voice over LTE terminal connected to the circuit-switched network.

22. The network node of claim 12, wherein:
the one or more processors are further configured to generate a P-Access Network Information (PANI) header that includes the stored access network information; and
the one or more processors configured to append the stored access network information to the response to the call setup message comprise one or more processors configured to append the generated PANI header to the response to the call setup message.
